(19) United States
(12) Patent Application Publication
(10) Pub. No.: US 2020/0144581 A1
(43) Pub. Date: May 7, 2020

(54) ENERGY STORAGE DEVICE

(71) Applicant: Dyson Technology Limited, Wiltshire (GB)

(72) Inventor: Andre Francois THUNOT, Bristol (GB)

(73) Assignee: Dyson Technology Limited, Wiltshire (GB)

(21) Appl. No.: 16/631,801

(22) PCT Filed: Jul. 17, 2018
(86) PCT No.: PCT/GB2018/052021

§ 371 Date: Jan. 16, 2020

(30) Foreign Application Priority Data
Jul. 18, 2017 (GB) 1711550.2

(51) Int. Cl. H01M 2/26; H01M 2/18; H01M 2/02

(52) U.S. Cl. CPC H01M 2/263; H01M 2/022; H01M 2/18

(57) ABSTRACT

An electrochemical storage device comprising a container, a sheet of cathode material, a sheet of anode material and a separator material. The electrode sheets being wound in the container about a winding axis to provide a cylindrical electrochemical cell assembly having a curved sidewall and two end faces. At least one of the sheets of the anode or cathode material has a plurality of tabs that extend from one end face of the cylindrical electrochemical cell assembly. The tabs are arranged on said end face in a spiral about the winding axis.

### CROSS-REFERENCE TO RELATED APPLICATIONS

This application is a national stage application under 35 U.S.C. 371 of International Application No. PCT/GB2018/052021, filed Jul. 17, 2018, which claims the priority of GB Application No. 1711550.2, filed Jul. 18, 2017, the entire contents of each of which are incorporated herein by reference.

### FIELD OF THE DISCLOSURE

The present invention relates to an electrochemical energy storage device. More specifically, the present invention relates to an arrangement of a sheet of conducting material for a wound electrochemical energy storage device.

### BACKGROUND OF THE DISCLOSURE

Wound cells are generally designed with a limited number of connections. Sheets of conducting material (e.g. a sheet of current collector material or an electrode) can be provided with connecting tabs, or tabs that are cut out from the sheets. Having cut tabs from a sheet is one way of improving the thermal conductivity of a cell. In contrast to systems having a single tab, cutting multiple tabs from a sheet also reduces the amount of waste material, since material is cut away and discarded to form the tabs. In addition, having multiple tabs on a conducting sheet can also reduce ohmic resistances, preventing large voltage drops at high current rates, and improving the overall energy of the electrochemical energy storage device.

There is therefore an incentive to increase the number of tabs. However, increasing the number of tabs can provide different challenges such as ways of packing and folding the excess material from the tabs. FIGS. 1 and 2 show a prior art example of an end face of a rolled sheet of conducting material with tabs. The tabs are arranged for folding such that the tabs will have electrical contact with each other when folded into an electrochemical device. However, the spatial volume occupied by the folded tabs is cumulative, such that the thickness of the combined tabs when folded affects the size of the electrochemical device. In addition, the difficulty of folding the amount of material shown in arrangement in FIGS. 1 and 2 also limit the number of tabs.

### SUMMARY OF THE DISCLOSURE

In a first aspect, the present invention provides a sheet of conducting material for an energy storage device, the sheet comprising a plurality of tabs that extend from a longitudinal side of the sheet, the sheet being windable about a winding axis normal the longitudinal side to create a plurality of windings; wherein the tabs are spaced along the longitudinal side such that when the sheet is wound about the winding axis the tabs are arranged in a spiral about the winding axis.

In second aspect, the present invention provides an electrochemical storage device comprising a container, a sheet of cathode material, a sheet of anode material and a separator material; the sheets being wound in the container about a winding axis to provide a cylindrical electrochemical cell assembly having a curved sidewall and two end faces; at least one of the sheets of the anode or cathode material has a plurality of tabs that extend from one end face of the cylindrical electrochemical cell assembly; wherein the tabs are arranged on said end face in a spiral about the winding axis.

The arrangement of tabs in a spiral shape about the winding axis of a conducting material sheet allows for ease of folding of the tabs while also greatly improving heat transfer across the cell. The spiralled tabs can be more readily folded as they are offset from each other. In addition, the number of tabs provided on the sheet of conducting material is not limited ultimately by the volume occupied by the bulk of the tabs when they are folded one on top of the other. Thus, the number of windings can be increased compared to electrochemical devices of the prior art, thereby increasing energy density and capacity of the electrochemical device of the present invention. The number of tabs can also be increase, providing a device with reduced voltage drops, improved thermal gradient and current density distribution, and increased thermal conductivity.

The tabs may be spaced along the longitudinal side such that a portion of a length of each tab overlaps with an adjacent tab when the rolled sheet is viewed along the winding axis. That is to say that the tabs may be spaced along the anode or cathode sheet such that a portion of a length of each tab overlaps with an adjacent tab when said end face of the cylindrical electrochemical cell assembly is viewed along the winding axis. In this particular embodiment the edges of each tab occupy a part of the length of the adjacent spiralled tab such that when folded, the tabs contact each other and aid in the folding of the tabs. This improves the ease of assembly of the electrochemical device, whilst also providing an electrical contact between the assembled tabs. Electrical connection between the tabs can be provided by, for example, spot or ultrasonic welding.

The tabs may be integral to the sheet of conducting material, i.e., cathode or anode sheet or current collector sheet. To prevent wasting materials, tabs can be assembled by welding a separate metallic strip directly onto an uncoated region of the conducting material instead of cutting tabs from a sheet of conducting material. However, increasing the number of welded tabs leads to greater uncoated regions, thus lowering the overall capacity of the electrochemical device. In addition, the winding efficiency of the roll of conducting material is increased since there are no offsets or discontinuities associated with welded tabs constructed from metallic strips. Since the tabs are spiralled when the sheet is wound, the number of tabs can be increased when compared to conventional tabbed sheets. This means that less wasted material is produced since more material for tabs can remain on the longitudinal edge of the conducting material sheet.

The length of each tab along the longitudinal side may increase as the space between the tabs increases. The length of the tabs is related to the thermal conductivity, such that an increased tab length improves the thermal conduction of heat. Thus, having tabs of a longer length at one end of a conducting sheet allows for thermal conduction in a certain direction. In a similar vein, the height of each tab extending away from the longitudinal side may be different. The tabs may increase in height along the longitudinal side as the space between the tabs increases. As well as aiding in thermal conduction, the tabs of greater height can be folded inwardly over tabs of smaller length ensuring that all tabs overlap. These differences in dimensions can be used separately or in conjunction. In a particular embodiment, the spiral of tabs may extend outwardly in a clockwise direction such that the tab having the shortest length and height is closest to the winding axis. In other words, the spiral travels in a clockwise direction from the outer most tab to the inner most tab. This particular embodiment provides larger tabs on the outer windings of the rolled substrate, thereby drawing heat away from the centre of the electrochemical device. In addition, the larger tabs can be folded and would reach the centre of the device. In another embodiment, the sheet may be rolled such that more than one spiral of tabs is formed on the end face.

Both the sheet of the anode and sheet of cathode material may comprise a plurality of tabs. The tabs of the sheet of anode material may occupy one end face, whilst the tabs of the sheet of cathode material occupy the other end face. The term anode sheet and cathode sheet is used to describe a conducting material that is, or forms part of, either the negative electrode or positive electrode of the electrochemical device. For example, the term anode sheet would cover a current collector sheet, an electrode sheet or a composite sheet. When both the anode sheet and cathode sheet have tabs, the overall performance of the device is improved as voltage drops are reduced, as well as thermal gradients and current density distribution. In addition, thermal conductivity of the electrochemical device is also improved.

The device may further comprise at least one washer on an end face of the cylindrical electrochemical cell assembly, the washer comprising a spiral slot for gathering the tabs of the sheets of the anode or cathode material. The provision of a spiral slot on the washer also allows for a larger area of the end face to be covered when compared to a washer for fitting over the tab arrangements of the prior art, thereby improving safety from short circuits. The washer may be formed of more than one part, such that when the tabs are folded, the parts of the washer are held in place.

### BRIEF DESCRIPTION OF THE FIGURES

In order to better understand the present invention, and to show more clearly how the invention may be put into effect, embodiments of the invention will now be described, by way of example, with reference to the following drawings:

FIG. 1 is a perspective view of cylindrical assembly for an electrochemical device forming the prior art;

FIG. 2 is a top view showing an end face of the cylindrical assembly of FIG. 1;

FIG. 3 is a perspective view of a cylindrical assembly for an electrochemical device, according to some embodiments;

FIG. 4 is a top view showing an end face of the cylindrical assembly of FIG. 3, according to some embodiments;

FIG. 5 is a top view showing an end face of an alternative cylindrical assembly, according to some embodiments;

FIG. 6 is a schematic of a sheet of conducting material, according to some embodiments; and

FIG. 7 is a schematic of a washer for use in the electrochemical device, according to some embodiments.

### DETAILED DESCRIPTION OF THE DISCLOSURE

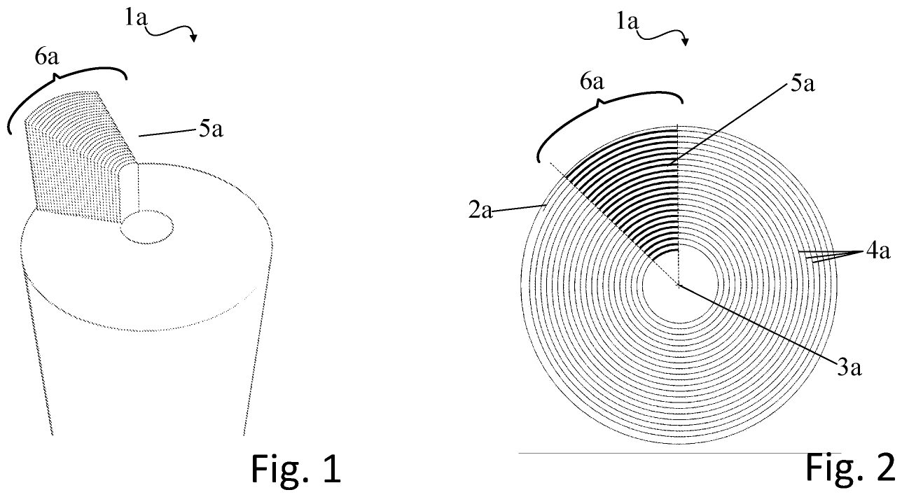

FIGS. 1 and 2 show schematics of jelly-roll cylindrical assembly 1 forming part of the prior art. The cylindrical assembly 1a can form part of an electrochemical device, and comprises a sheet of conducting material 2a which is wound about a winding axis 3a to provide cylindrically shaped roll with a plurality of windings 4a. The windings 4a each have a tab 5a. When wound, the tabs 5a assemble and collect in a sector 6a on the top face (shown in top view in FIG. 2) of the rolled sheet of conducting material 2a. The tabs 5a can then be folded onto each other and welded to a part of the electrochemical device.

A washer (not shown as part of the device) can be placed on top of the windings to isolate part of the electrochemical device. The washer is formed such that it is generally circular in shape with a sector of material removed so as to accommodate the sector of the assembled tabs 6a.

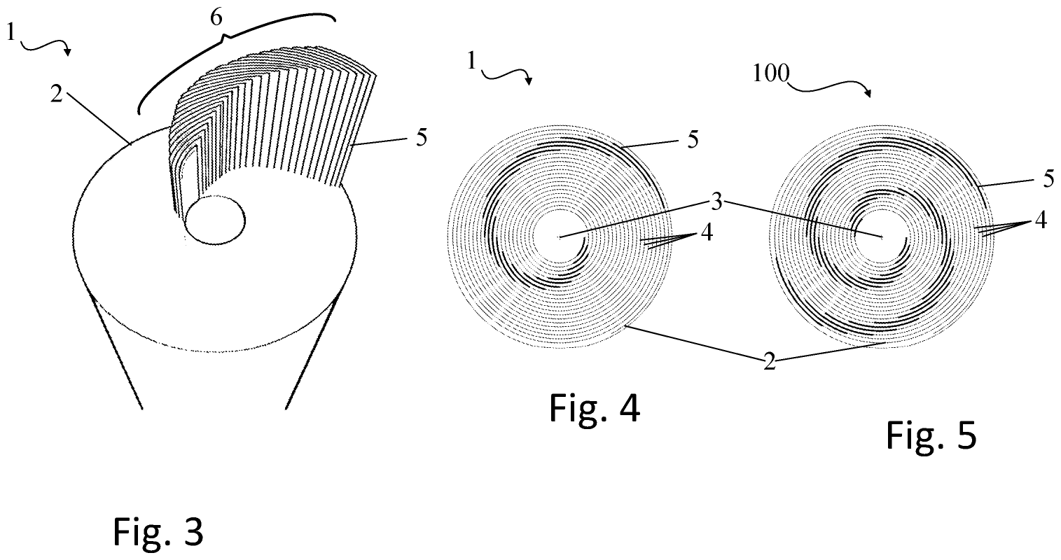

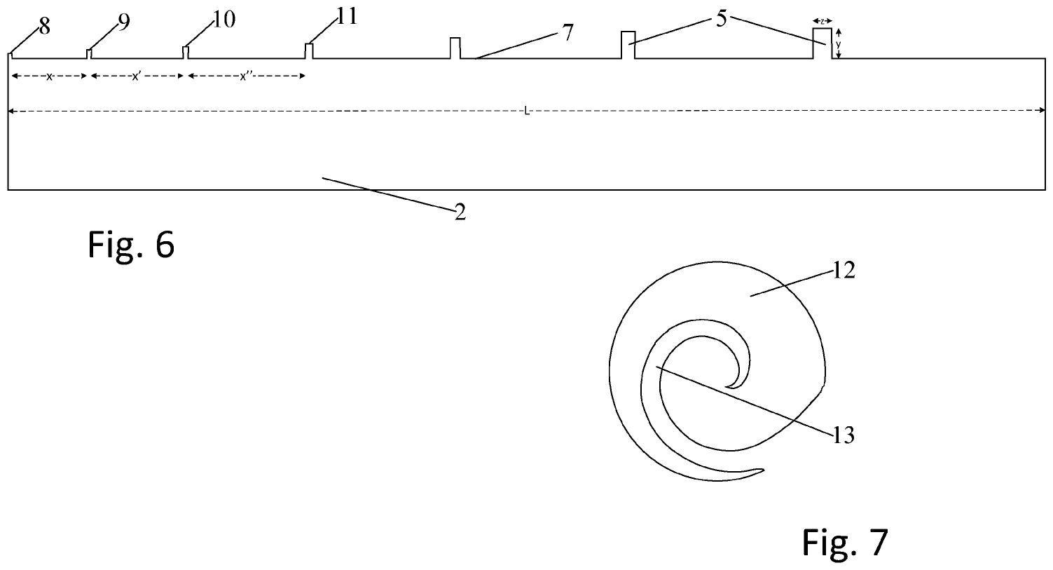

FIGS. 3 to 5 show schematics of a jelly-roll cylindrical assembly 1 in accordance with the present invention. The cylindrical assembly 1 can form part of an electrochemical device. FIGS. 6 and 7 show composite parts of an electrochemical device, specifically FIG. 6 shows a sheet of conducting material and FIG. 7 shows a washer.

FIGS. 3 and 4 show a cylindrical assembly 1 that comprises a sheet of conducting material 2 which is wound about a winding axis 3 to provide cylindrically shaped roll with a plurality of windings 4. The windings 4 have at least one tab 5. When wound, the tabs 5 assemble into a spiral formation on the top face (shown in top view in FIG. 4) of the rolled sheet of conducting material 2. The tabs 5 are spaced and sized such that a portion of a length of each tab 5 overlaps with an adjacent tab 5 when the rolled sheet is viewed along the winding axis 3. This is shown in FIGS. 3 and 4. The tabs 5 increase in height Y and length Z as the spiral 6 extends towards the outside surface of the cylindrically assembly 1. The tabs 5 can then be folded and welded to a part of the electrochemical device. An alternative cylindrical assembly 100 with a different formation of spiralled tabs 5 is shown in FIG. 5, in which the tabs are arranged to form two spirals radiating out from the winding axis 3.

The sheet of conducting material 2 is shown in more detail in FIG. 6. The sheet 2 has a longitudinal length L and a longitudinal side 7. The sheet 2 comprises a plurality of tabs 5 which are spaced along one longitudinal side 7 of the sheet. The spacing between the adjacent tabs increases in one direction along the longitudinal length L of the sheet. As shown in FIG. 6 reading along the longitudinal side 7 from left to right, the space X between the first tab 8 and the second tab 9 is less than the space X′ between the second tab 9 and the third tab 10. Furthermore, the space X′ between the second tab 9 and the third tab 10 is less than the space X″ between the third tab 10 and the fourth tab 11. The increase in the space X, X′, X″ between the tabs 5 is calculated such that when rolled about a winding axis 3, the tabs 5 on the sheet 2 are arranged in a spiral formation on a top face of the cylindrical assembly 1.

In addition to the varying spaces between tabs 5 along the longitudinal length L of the sheet 2, the tabs 5 themselves vary in both height Y and length Z. Specifically, the tabs 5 increase in both height Y and length Z along the longitudinal length L as the space between the tabs 5 increases. In other words, a first tab 8 has a smaller height and length than its adjacent tab 9, and every other tab 10,11 along the longitudinal side 7 of the sheet 2. The space between the tabs 5, and their height and length is such that when the sheet 2 is wound about a winding axis 3, the tabs 5 can arrange into an ordered spiral pattern 6 with sufficient tab overlap.

The cylindrical assembly 1 can comprise a second sheet of conducting material 2. This second sheet 2 can take the form of a current collector or electrode. When the two sheets 2 are wound and combined into a cylindrical assembly 1, the tabs 5 can occupy both end faces (i.e. top and bottom faces). Both tab 5 arrangements can be spiralled 6.

FIG. 7 shows a washer 12 that can be placed over an end face of the cylindrical assembly 1. The washer 12, has a spiralled slot 13 that can accommodate the spiral arrangement 6 of the tabs 5 when the sheet 2 is wound about a winding axis 3. The tabs 5 are arranged such that as the washer 12 is placed and fed onto the end face of the cylindrical assembly 1, around the spiral 6, the tabs 5 can be folded from the outside winding 4 on top of one another.

The cylindrical assembly 1 is manufactured as follows. A sheet 2 of conducting material is cut such that tabs 5 remain along a longitudinal side 7. The length and height of each tab 5 varies such that both the length and height increase along the longitudinal side 7, and the space between the tabs increase along the longitudinal length L of the sheet 2.

The cut sheet 2 is rolled about a winding axis 2. The tabs 5 are cut in such a way that when the sheet 2 is rolled, the tabs 5 align in a spiral pattern 6 on a top face of the rolled sheet 2. The rolled conducting sheet 2 will also include other materials, such an electrode sheet and electrolyte material. Once the sheet 2 has been rolled, a washer 7 is fitted onto the end face of the sheet 2 with the tabs 5 such that the tabs are fed through the spiralled slot 13. The tabs 5 can then be folded over the washer 12 and welded to another part of an energy storage device.

1. A sheet of conducting material for an energy storage device, the sheet comprising:
a plurality of tabs that extend from a longitudinal side of the sheet, the sheet being windable about a winding axis normal the longitudinal side to create a plurality of windings,
wherein the tabs are spaced along the longitudinal side such that when the sheet is wound about the winding axis the tabs are arranged in a spiral about the winding axis.

2. The sheet of claim 1, wherein the tabs are spaced along the longitudinal side such that a portion of a length of each tab overlaps with an adjacent tab when the rolled sheet is viewed along the winding axis.

3. The sheet of claim 1, wherein the tabs are integral to the sheet of conducting material.

4. The sheet of claim 1, wherein the length of each tab along the longitudinal side increases as the space between the tabs increases.

5. The sheet of claim 1, wherein the height of each tab extending away from the longitudinal side is different.

6. The sheet of claim 5, wherein the tabs increase in height along the longitudinal side as the space between the tabs increases.

7. The sheet of claim 4, wherein when the sheet is wound, the spiral of tabs extends outwardly such that the tab having at least one of the shortest length or the shortest height is closest to the winding axis.

8. The sheet of claim 1, wherein when the sheet is wound about the winding axis, the tabs are arranged in more than one spiral about the winding axis.

9. An electrochemical energy storage device comprising:
a container;
a sheet of cathode material;
a sheet of anode material; and
a separator material,
wherein the sheets wound in the container about a winding axis provide a cylindrical electrochemical cell assembly having a curved sidewall and two end faces wherein at least one of the sheet of anode material or the sheet of cathode material comprises a plurality of tabs that extend from one end face of the cylindrical electrochemical cell assembly, and wherein the tabs are arranged on a first end face of the two end faces in a spiral about the winding axis.

10. The device of claim 9, wherein the tabs are spaced along the anode or cathode sheet such that a portion of a length of each tab overlaps with an adjacent tab when the first end face of the cylindrical electrochemical cell assembly is viewed along the winding axis.

11. The device of claim 9, wherein the tabs are integral to the at least one of the sheet of anode or cathode material.

12. The device of claim 9, wherein the length of each tab along a longitudinal side increases as the space between the tabs increases.

13. The device of claim 9, wherein the height of each tab extending away from said end face is different.

14. The device of claim 13, wherein the tabs increase in height along a longitudinal side as the space between the tabs increases.

15. The device of claim 14, wherein the tabs increase in height and length around the spiral from the center of said end face, such that the tab having the shortest length and height is closest to the winding axis.

16. The device of claim 9, wherein both the sheet of anode material and the sheet of cathode material comprise a plurality of tabs.

17. The device of claim 16, wherein the tabs of the sheet of anode material occupy one end face, and the tabs of the sheet of cathode material occupy the other end face.

18. The device of claim 17, wherein at least one of the tabs of the sheet of anode material or the tabs of the sheet of cathode material are arranged in more than one spiral about the winding axis.

19. The device of claim 9, wherein the device further comprises at least one washer on an end face of the cylindrical electrochemical cell assembly, the washer comprising a spiral slot for gathering the tabs of the sheets of the anode or cathode material.

20. The device of claim 19, wherein the at least one washer is formed of more than one part, such that when the tabs are folded, the parts of the washer are held in place.
